(19) United States
(12) Patent Application Publication
(10) Pub. No.: US 2015/0222188 A1
(43) Pub. Date: Aug. 6, 2015

(54) HIGH FREQUENCY TRANSFORMER FOR REDUCING LEAKAGE FLUX

(71) Applicant: KOREA RAILROAD RESEARCH INSTITUTE, Uiwang-si (KR)

(72) Inventors: Jeong Min JO, Suwon-si (KR); Young Jae HAN, Seoul (KR); Chang Young LEE, Bucheon-si (KR); Hyun Seung JEONG, Seongnam-si (KR); Sung Il SEO, Seoul (KR)

(21) Appl. No.: 14/579,959

(22) Filed: Dec. 22, 2014

(30) Foreign Application Priority Data
Feb. 3, 2014 (KR) 10-2014-0012315
Oct. 30, 2014 (KR) 10-2014-0149674

(51) Int. Cl. H02M 3/335; H01F 27/40; H01F 27/34; H01F 27/28

(52) U.S. Cl. CPC H02M 3/335; H01F 27/2823; H01F 27/40; H01F 27/346; H01F 2027/408

(57) ABSTRACT

Disclosed is a high frequency transformer for reducing leakage flux, including a voltage transformation unit for transforming a first voltage, which is inputted thereto, into a second voltage, wherein: a primary winding is divided; and a secondary winding is arranged between the divided primary windings.

### STATEMENT REGARDING PRIOR DISCLOSURES

Korean Application No. 10-2012-0135618 which was filed on Nov. 27, 2012, and published on Jan. 23, 2014, as Korean Patent Publication 10-1353899, has the same inventorship as the present application and does not qualify as prior art under AIA 35 U.S.C. 102(b)(1)(A).

### BACKGROUND

Exemplary embodiments of the present invention relate to a high frequency transformer for reducing leakage flux, and more particularly, to a high frequency transformer for reducing leakage flux in which a primary winding of the transformer is divided and a secondary winding is disposed between the divided primary windings, thereby significantly reducing leakage flux.

In addition, exemplary embodiments of the present invention relate to an auxiliary power device of a railroad vehicle in which the high frequency transformer for reducing leakage flux is adopted.

Generally, on a railroad vehicle, various electronic units required for the operation of the railroad vehicle are mounted, wherein the electronic units operate with power supplied from a main power source to perform some functions of various functions required for the operation of the railroad vehicle.

FIG. 1 is a view illustrating a conventional power circuit of a railroad vehicle.

Referring to FIG. 1, the conventional power circuit is configured in such a manner as to provide one fuse BF1 between a power source and a DC load, which is constituted by several electronic units, so as to protect the electronic units constituting the DC load from overcurrent which is caused by a short circuit or a ground fault in the DC load.

However, according to the conventional manner, when a short circuit or a ground fault occurs in any one of the electronic units constituting the DC load, the fuse operates to cut off the supply of power to the entire DC load, i.e. to the entire electronic units.

In more detail, for example, even when a problem occurs in an electronic unit, e.g. in an electronic unit for controlling some lamps in a passenger room, which is not much related to the operation safety of a railroad vehicle, the supply of power to all the electronic units is cut off in order to prevent the corresponding electrode unit from being damaged, which acts to significantly reduce the safety and efficiency in the operation of the railroad vehicle.

In order to solve such a technical problem, Korean Patent Registration No. 10-1099567 titled “POWER SUPPLY CIRCUIT OF RAILROAD VEHICLE” discloses a power circuit in which an emergency load preset according to the importance on the operation of a railroad vehicle is configured to be supplied with power from an auxiliary power device, such as a battery, mounted on the railroad vehicle, so that a problem caused in a load having a low importance on the operation does not exert an effect on an important load for the operation of the railroad vehicle.

As such an auxiliary power device, a high frequency transformer for a DC/DC converter is widely used. FIG. 2 illustrates a primary winding and a secondary winding which are wound on a conventional high frequency transformer for a DC/DC converter.

Referring to FIG. 2, generally, a leakage inductance is caused by leakage flux. That is to say, flux generated by a primary winding is divided into mutual flux interlinked through a secondary winding, and leakage flux which is not interlinked through the secondary winding and is lost.

As illustrated in FIG. 2, since the primary winding and the secondary winding wound on the conventional high frequency transformer for a DC/DC converter are repeatedly stacked and wound, the directions of flux between the primary and secondary windings may coincide with each other. Accordingly, leakage flux occurs, so that a leakage inductance may increase.

As described above, when a leakage inductance increases, the configuration can be applied only to a small scale system, but cannot be applied to a large scale system.

In addition, when a DC/DC converter using a split capacitor is implemented for a large scale system, the charging voltage of the split capacitor increases due to a high stress inductance of a large scale high-frequency transformer. Therefore, a DC/DC converter using a split capacitor can be applied only to a small scale system.

### PRIOR ART DOCUMENT

### Patent Document

Korean Patent Application Publication No. 10-2011-0087419

### SUMMARY

An embodiment of the present invention relates to a high frequency transformer for reducing leakage flux which can significantly reduce leakage flux and can be applied to a large scale system by dividing a primary winding of the transformer and disposing a secondary winding thereof between the divided primary windings.

Another embodiment of the present invention relates to an auxiliary power device for a railroad vehicle which includes a high frequency transformer for reducing leakage flux in which a primary winding of the transformer is divided and a secondary winding thereof is disposed between the divided primary windings, thereby significantly reducing leakage flux and thus simplifying a large scale system.

In addition, exemplary embodiments of the present invention relate to a high frequency transformer for reducing leakage flux a primary winding of the transformer is divided and a secondary winding thereof is disposed between the divided primary windings, thereby simplifying a large scale system and thus lightening a high frequency switching system when the high frequency transformer is applied to an auxiliary power device for a railroad vehicle.

In one embodiment, a high frequency transformer for reducing leakage flux includes a voltage transformation unit for transforming a first voltage, which is inputted thereto, into a second voltage, wherein: a primary winding is divided; and a secondary winding is arranged between the divided primary windings.

In addition, a direction of flux by the divided primary windings and a direction of flux by the secondary winding may be opposite to each other.

In addition, the divided primary windings may be formed to have an equal thickness.

In addition, the high frequency transformer for reducing leakage flux may further include: an input terminal unit configured to receive the first voltage as an input thereof; a switching unit configured to perform a switching operation on the first voltage supplied from the input terminal unit; a division storage unit disposed between the input terminal unit and the switching unit and configured to store energy which is accumulated by a leakage inductance generated in the voltage transformation unit; a rectifying unit configured to rectify the second voltage supplied from the voltage transformation unit; a filtering unit configured to filter the second voltage, which has been rectified by the rectifying unit; and an output terminal unit configured to output the second voltage, which has been filtered by the filtering unit.

In addition, the division storage unit may include a first division storage unit and a second division storage unit, wherein the first division storage unit and the second division storage unit may be coupled in series to each other, and the voltage transformation unit may be coupled between the first division storage unit and the second division storage.

In addition, the switching unit may include a first switching unit and a second switching unit, wherein at least one of the first and second switching units may be turned on to supply the first voltage to the voltage transformation unit or to cut off the supply of the first voltage to the voltage transformation unit.

In addition, a first input terminal of the voltage transformation unit may be coupled between the first switching unit and the second switching unit, and a second input terminal of the voltage transformation unit may be coupled between the first division storage unit and the second division storage unit.

In addition, the rectifying unit may include a bridge rectifying circuit, and each terminal of the secondary winding of the voltage transformation unit may be coupled to the bridge rectifying circuit.

In addition, the filtering unit may include a capacitor which is coupled to both terminals of the bridge rectifying circuit.

In addition, the bridge rectifying circuit may include first to fourth diodes, wherein a first output terminal of the secondary winding of the voltage transformation unit may be coupled between the first diode and the second diode, and a second output terminal of the secondary winding of the voltage transformation unit may be coupled between the third diode and the fourth diode.

In addition, the primary winding and secondary winding of the voltage transformation unit may be configured in multiple layers, and each layer of the secondary winding may be arranged between the respective layers of the primary winding.

In addition, the high frequency transformer may further include an insulating paper inserted between each layer of the primary winding and each layer of the secondary winding.

In addition, the primary winding and the secondary winding may be configured in an equal number of layers.

In addition, a structure in which the secondary winding is disposed between the primary windings may be achieved in such a manner as to wind a part of the primary winding, to wind the secondary winding thereon, and to wind a remaining part of the primary winding thereon.

In addition, the respective thicknesses of the divided primary windings may be set to minimize leakage flux by keeping a balance between a direction of flux by the primary windings and a direction of flux by the secondary winding.

In addition, a resonant frequency may be determined by resonance between a capacitance of the division storage unit and a leakage inductance generated in the voltage transformation unit.

In addition, the resonant frequency may be determined in such a manner as to minimize the leakage inductance and to maximize the capacitance of the division storage unit.

In addition, the high frequency transformer may be applied to an auxiliary power device for a railroad vehicle.

In another embodiment, an auxiliary power device for a railroad vehicle, to which the high frequency transformer for reducing leakage flux according to any one of claims 1 to 18 is applied, is provided.

### BRIEF DESCRIPTION OF THE DRAWINGS

The above and other aspects, features and other advantages will be more clearly understood from the following detailed description taken in conjunction with the accompanying drawings, in which:

FIG. 1 a view illustrating a conventional power circuit of a railroad vehicle;

FIG. 2 is a view explaining a primary winding and a secondary winding which are wound on a conventional high frequency transformer for a DC/DC converter;

FIG. 3 is a view explaining a circuit of a high frequency transformer for reducing leakage flux according to an embodiment of the present invention;

FIGS. 4 and 5 are views explaining a primary winding and a secondary winding which are wound on a high frequency transformer for reducing leakage flux according to an embodiment of the present invention; and

FIG. 6 is a three-dimensional view illustrating a primary winding and a secondary winding which are wound on a high frequency transformer for reducing leakage flux according to an embodiment of the present invention.

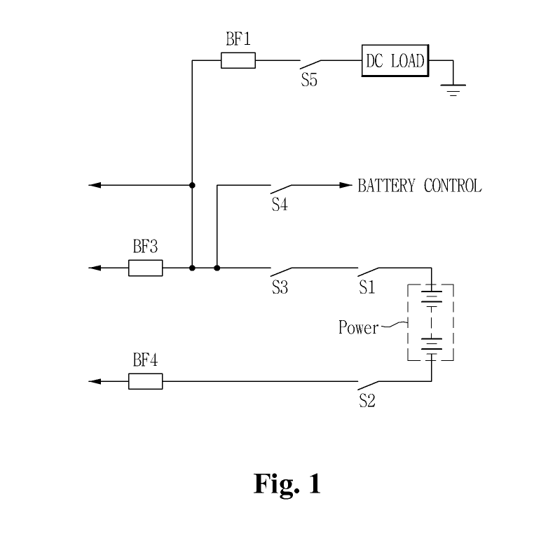

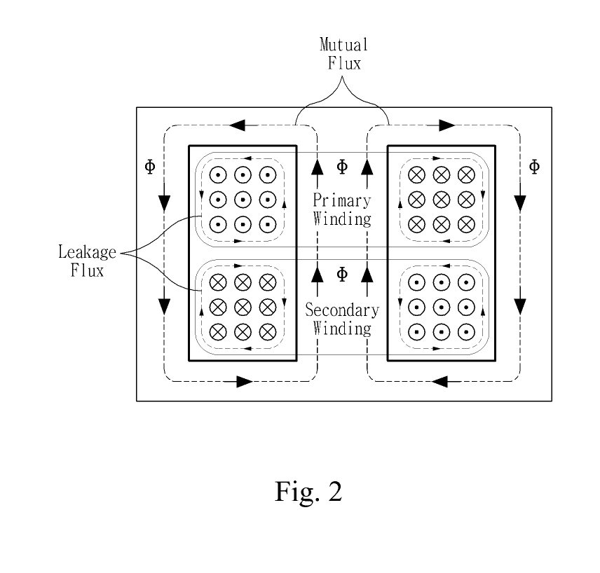

### DESCRIPTION OF SPECIFIC EMBODIMENTS

Hereinafter, embodiments of the present invention will be described with reference to accompanying drawings. However, the embodiments are for illustrative purposes only and are not intended to limit the scope of the invention.

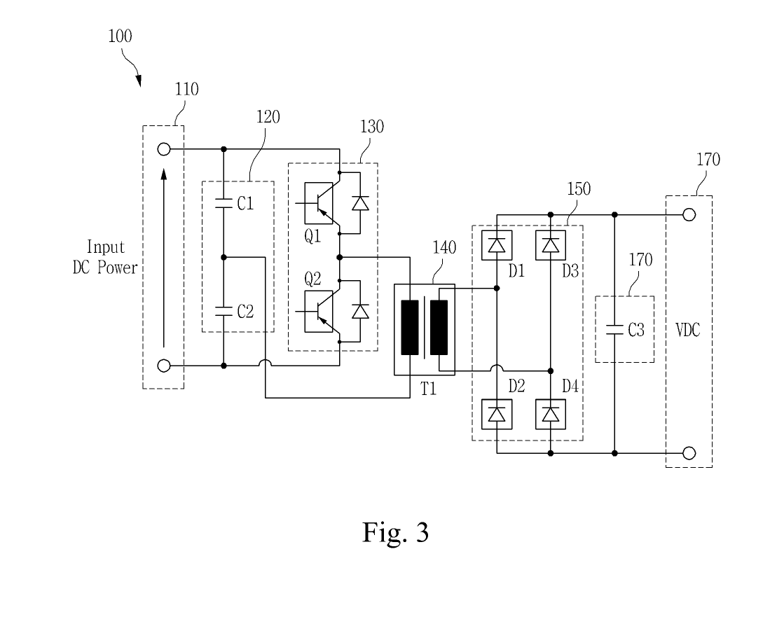

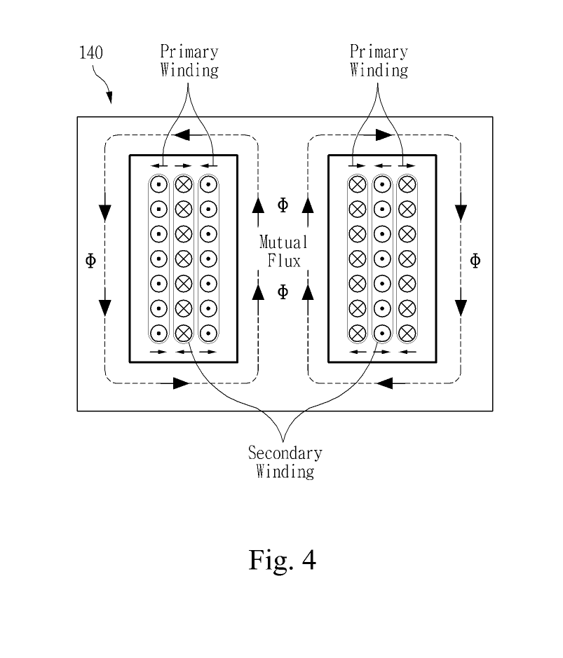

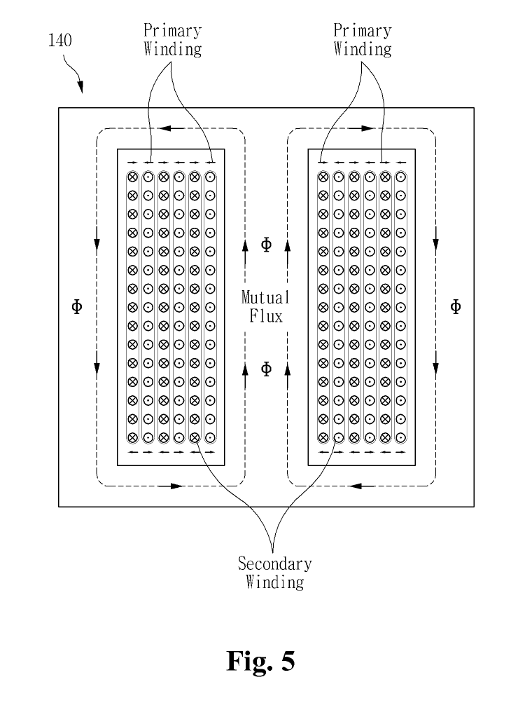

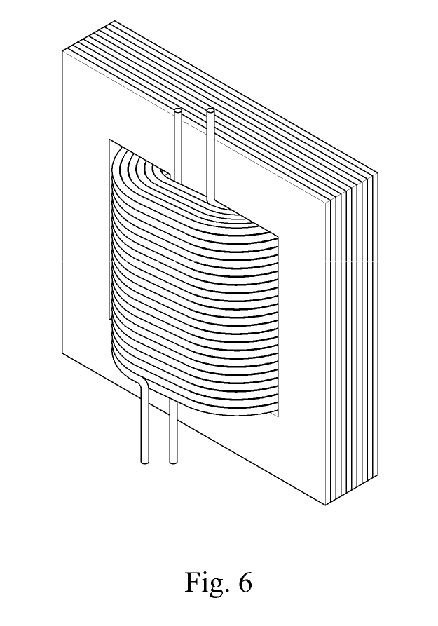

FIG. 3 is a view explaining a circuit of a high frequency transformer for reducing leakage flux according to an embodiment of the present invention, and FIGS. 4 and 5 are views explaining a primary winding and a secondary winding which are wound on a high frequency transformer for reducing leakage flux according to an embodiment of the present invention. In addition, FIG. 6 is a three-dimensional view illustrating a primary winding and a secondary winding which are wound on a high frequency transformer for reducing leakage flux according to an embodiment of the present invention.

Referring to FIG. 3, a high frequency transformer 100 for reducing leakage flux according to an embodiment of the present invention includes an input terminal unit 110, a switching unit 130, a voltage transformation unit 140, a division storage unit 120, a rectifying unit 150, a filtering unit 160, and an output terminal unit 170.

The input terminal unit (e.g. Input DC power) 110 receives a first voltage as an input. The input terminal unit 110 is supplied with the first voltage from an exterior or a voltage generation device (not shown) capable of generating a voltage.

The switching unit 130 performs a switching function on the first voltage supplied from the input terminal unit 110. The switching unit 130 may be constituted by a first switching unit Q1 and a second switching unit Q2. When the switching unit 130 is supplied with the first voltage, the first switching unit Q1 and/or the second switching unit Q2 is turned on to supply the first voltage to the voltage transformation unit 140 to be described later or to cut off the supply of the first voltage.

Here, the first switching unit Q1 and the second switching unit Q2 may include an insulated gate bipolar transistor (IGBT).

The division storage unit 120 is disposed between the input terminal unit 110 and the switching unit 130, and stores energy which is accumulated by a leakage inductance generated in the voltage transformation unit 140. The division storage unit 120 may include a capacitor.

Here, the division storage unit 120 may include a first division storage unit C1 and a second division storage unit C2. In this case, the first division storage unit C1 and the second division storage unit C2 may be connected in series to each other. Accordingly, the voltage transformation unit 140 is electrically connected between the first division storage unit C1 and the second division storage unit C2. That is to say, the voltage transformation unit 140 may be electrically connected to one end of the first division storage unit C1 and one end of the second division storage unit C2.

The rectifying unit 150 rectifies a second voltage supplied from the voltage transformation unit 140. The rectifying unit 150 may include a first diode D1 and a second diode D2.

The filtering unit 160 filters the second voltage, which has been rectified by the rectifying unit 150. The filtering unit 160 may include a capacitor C3. By configuring the rectifying unit 150 and the filtering unit 160, as described above, it is possible to significantly reduce the noise of the second voltage supplied from the voltage transformation unit 140.

The output terminal unit 170 outputs the second voltage, which has been filtered by the filtering unit 160. That is to say, the output terminal unit 170 can output the second voltage, the noise of which has been significantly reduced through the rectifying unit 150 and the filtering unit 160, to the outside.

Referring to FIGS. 4 and 5, the voltage transformation unit (T1) 140 has a primary winding divided and a secondary winding disposed between the divided primary windings, and transforms the first voltage, which is inputted through the switching unit 130, into a second voltage. That is to say, the voltage transformation unit 140 is configured in such a manner that not all, but only a part, of the primary winding is wound on a core, the other part of the primary winding is reserved, and then the secondary winding is wound. After the secondary winding has been finished, the reserved part of the primary winding is wound on the secondary winding, which has been wound. In other words, as shown in FIGS. 3 and 4, the voltage transformation unit 140 is wound in order of the primary winding, the secondary winding, and the primary winding. In this case, the primary winding and the secondary winding are wound in a ratio of n:n in the number of times of winding thereof, wherein it is preferred that the “n” is three or less. Since the voltage transformation unit 140 is configured in such a manner as to divide the primary winding and to dispose the secondary winding between the divided primary windings, as described above, the direction of flux by the divided primary windings and the direction of flux by the secondary winding can be opposite to each other. Accordingly, leakage flux is not generated, so that a leakage inductance can be minimized.

In this case, the thicknesses of the divided primary windings may be substantially formed to be equal to each other. That is to say, the primary windings divided into both sides, centering around the secondary winding, may be substantially formed to have substantially the same thickness. Thus, a balance between the direction of flux by the divided primary windings and the direction of flux by the secondary winding, which are opposite to each other, can be easily achieved. Accordingly, leakage flux is not generated, and thus a leakage inductance can be minimized.

In the high frequency transformer 100 for reducing leakage flux according to an embodiment of the present invention, described above, a first input terminal of the primary winding of the voltage transformation unit 140 is electrically connected between the first switching unit Q1 and the second switching unit Q2, a second input terminal of the primary winding of the voltage transformation unit 140 is electrically connected between the first division storage unit C1 and the second division storage unit C2, a first output terminal of the secondary winding of the voltage transformation unit 140 is electrically connected between the first diode D1 and the second diode D2, and a second output terminal of the secondary winding of the voltage transformation unit 140 is electrically connected between a third diode D3 and a fourth diode D4.

In addition, the high frequency transformer 100 for reducing leakage flux according to an embodiment of the present invention, described above, may use a resonance between leakage inductances generated in the division storage unit 120 and voltage transformation unit 140. In this case, Equation 1 below may be applied for the generation of resonance.

$$f = \frac{1}{2 π \sqrt{LC}} \qquad ( 1 )$$

According to Equation 1 above, it is necessary to increase “f” in order to reduce the size of the voltage transformation unit 140. To this end, it is preferred to minimize the leakage inductance L of the voltage transformation unit 140 or the value of “C” of the division storage unit 120. Therefore, when a resonant frequency is determined to be a specific frequency, it may be preferred that the value of “C” of the division storage unit 120 is low when the leakage inductance of the voltage transformation unit 140 is high. In contrast, when a resonant frequency is determined to be a specific frequency, it may be preferred that the value of “C” of the division storage unit 120 is high when the leakage inductance of the voltage transformation unit 140 is low.

According to an embodiment of the present invention, the high frequency transformer for reducing leakage flux can significantly reduce leakage flux by dividing a primary winding of the transformer and disposing a secondary winding thereof between the divided primary windings.

According to another embodiment of the present invention, the auxiliary power device for a railroad vehicle including the high frequency transformer for reducing leakage flux can significantly reduce leakage flux by dividing a primary winding of the transformer and disposing a secondary winding thereof between the divided primary windings, and thus can simplify a large scale system.

According to another embodiment of the present invention, the auxiliary power device for a railroad vehicle including the high frequency transformer for reducing leakage flux can simplify a large scale system by dividing a primary winding of the transformer and disposing a secondary winding thereof between the divided primary windings, and thus can lighten a high frequency switching system when the high frequency transformer is applied to the auxiliary power device for a railroad vehicle.

The high frequency transformer for reducing leakage flux according to the embodiments of the present invention has been disclosed above for illustrative purposes. Those skilled in the art will appreciate that various modifications, additions and substitutions are possible, without departing from the scope and spirit of the invention as disclosed in the accompanying claims. In addition, the present invention should be appreciated to include all the changes, equivalents and replacements which fall in the spirit and technical scope of the present invention.

What is claimed is:

1. A high frequency transformer for reducing leakage flux, comprising a voltage transformation unit for transforming a first voltage, which is inputted thereto, into a second voltage, wherein:
a primary winding is divided; and
a secondary winding is arranged between the divided primary windings.

2. The high frequency transformer of claim 1, wherein a direction of flux by the divided primary windings and a direction of flux by the secondary winding are opposite to each other.

3. The high frequency transformer of claim 1, wherein the divided primary windings are formed to have an equal thickness.

4. The high frequency transformer of claim 1, wherein the high frequency transformer for reducing leakage flux further comprises:
an input terminal unit configured to receive the first voltage as an input thereof;
a switching unit configured to perform a switching operation on the first voltage supplied from the input terminal unit;
a division storage unit disposed between the input terminal unit and the switching unit and configured to store energy which is accumulated by a leakage inductance generated in the voltage transformation unit;
a rectifying unit configured to rectify the second voltage supplied from the voltage transformation unit;
a filtering unit configured to filter the second voltage, which has been rectified by the rectifying unit; and
an output terminal unit configured to output the second voltage, which has been filtered by the filtering unit.

5. The high frequency transformer of claim 4, wherein the division storage unit comprises a first division storage unit and a second division storage unit, wherein the first division storage unit and the second division storage unit are coupled in series to each other, and the voltage transformation unit is coupled between the first division storage unit and the second division storage.

6. The high frequency transformer of claim 4, wherein the switching unit comprises a first switching unit and a second switching unit, wherein at least one of the first and second switching units is turned on to supply the first voltage to the voltage transformation unit or to cut off the supply of the first voltage to the voltage transformation unit.

7. The high frequency transformer of claim 6, wherein the division storage unit comprises a first division storage unit and a second division storage unit, wherein the first division storage unit and the second division storage unit are coupled in series to each other.

8. The high frequency transformer of claim 7, wherein a first input terminal of the voltage transformation unit is coupled between the first switching unit and the second switching unit, and a second input terminal of the voltage transformation unit is coupled between the first division storage unit and the second division storage unit.

9. The high frequency transformer of claim 8, wherein the rectifying unit comprises a bridge rectifying circuit, and each terminal of the secondary winding of the voltage transformation unit is coupled to the bridge rectifying circuit.

10. The high frequency transformer of claim 9, wherein the filtering unit comprises a capacitor which is coupled to both terminals of the bridge rectifying circuit.

11. The high frequency transformer of claim 9, wherein the bridge rectifying circuit comprises first to fourth diodes, wherein a first output terminal of the secondary winding of the voltage transformation unit is coupled between the first diode and the second diode, and a second output terminal of the secondary winding of the voltage transformation unit is coupled between the third diode and the fourth diode.

12. The high frequency transformer of claim 1, wherein the primary winding and secondary winding of the voltage transformation unit are configured in multiple layers, and each layer of the secondary winding is arranged between the respective layers of the primary winding.

13. The high frequency transformer of claim 1, further comprising an insulating paper inserted between each layer of the primary winding and each layer of the secondary winding.

14. The high frequency transformer of claim 1, wherein the primary winding and the secondary winding are configured in an equal number of layers.

15. The high frequency transformer of claim 1, wherein a structure in which the secondary winding is disposed between the primary windings is achieved in such a manner as to wind a part of the primary winding, to wind the secondary winding thereon, and to wind a remaining part of the primary winding thereon.

16. The high frequency transformer of claim 1, wherein the respective thicknesses of the divided primary windings are set to minimize leakage flux by keeping a balance between a direction of flux by the primary windings and a direction of flux by the secondary winding.

17. The high frequency transformer of claim 4, wherein a resonant frequency is determined by resonance between a capacitance of the division storage unit and a leakage inductance generated in the voltage transformation unit.

18. The high frequency transformer of claim 17, wherein the resonant frequency is determined in such a manner as to minimize the leakage inductance and to maximize the capacitance of the division storage unit.

19. The high frequency transformer of claim 1, wherein the high frequency transformer is applied to an auxiliary power device for a railroad vehicle.

20. An auxiliary power device for a railroad vehicle, to which the high frequency transformer for reducing leakage flux according to claim 1 is applied.
